(19) United States
(12) Patent Application Publication
(10) Pub. No.: US 2026/0157440 A1
(43) Pub. Date: Jun. 11, 2026

(54) ATOMIZATION CORE, ATOMIZER, AND ELECTRONIC ATOMIZATION DEVICE

(71) Applicant: SMOORE INTERNATIONAL HOLDINGS LIMITED, Grand Cayman (KY)

(72) Inventors: Ming LV, Shenzhen (CN); Xueqin HE, Shenzhen (CN); Wei WANG, Shenzhen (CN); Guangwu TANG, Shenzhen (CN); Xianjun FU, Shenzhen (CN)

(73) Assignee: SMOORE INTERNATIONAL HOLDINGS LIMITED, Grand Cayman (KY)

(21) Appl. No.: 19/537,689

(22) Filed: Feb. 12, 2026

Related U.S. Application Data
(63) Continuation of application No. PCT/CN2024/101666, filed on Jun. 26, 2024.

(30) Foreign Application Priority Data
Aug. 17, 2023 (CN) 202311040870.7

(51) Int. Cl. A24F 40/46

(52) U.S. Cl. CPC A24F 40/46

(57) ABSTRACT

An atomization core, an atomizer, and an electronic atomization device are provided. The atomization core includes a porous substrate, a heating element, and a transition layer between the porous substrate and the heating element. The transition layer at least partially fills and/or covers the porous substrate.

### RELATED APPLICATIONS

This application is a continuation application of International application No. PCT/CN2024/101666, filed on Jun. 26, 2024, which claims priority to Chinese Patent Application No. 202311040870.7, filed on Aug. 17, 2023. The entire disclosure of the prior applications is hereby incorporated by reference.

### TECHNICAL FIELD

The present disclosure relates to the technical field of electronic atomization devices, including to an atomization core, an atomizer, and an electronic atomization device.

### BACKGROUND

Conventional electronic atomization devices typically utilize an atomization core to atomize an atomization substance. An atomization core generally includes a porous substrate and a heating element. In the prior art, porous ceramic is commonly used as the porous substrate, and a conductive metal material serves as the heating element. The conductive metal heating element is usually fixed by being embedded into the porous ceramic substrate. An atomization core obtained in this manner suffers from problems such as short service life and tendency to cause dry heating.

### SUMMARY

The objective of the present disclosure is to overcome the defects in the prior art, such as short service life of an atomization core and its tendency to cause dry heating, by providing an atomization core, an atomizer, and an electronic atomization device.

To achieve the above objective, the present disclosure adopts the following technical solution:

The present disclosure provides an atomization core, including a porous substrate, a heating element, and a transition layer bonded between the porous substrate and the heating element, where the transition layer contains an inorganic material component.

The transition layer contains a glassy phase;
and/or, the porous substrate contains a glassy phase and/or a ceramic phase;
the softening point temperature of glass in the transition layer is 400° C. to 1100° C.

The content of the inorganic material component in the transition layer is greater than 80 wt %;
the content of the inorganic material component in the transition layer is greater than 90 wt %;
the content of the inorganic material component in the transition layer is 100 wt %.

The transition layer at least partially fills and/or covers the porous substrate;
the transition layer at least partially fills and/or covers an area where the heating element is in contact with the porous substrate;
an area on the porous substrate not in contact with the heating element is at least partially not filled and/or covered by the transition layer.

The transition layer fills part of pores of the porous substrate, forming an embedded structure; and/or, the transition layer is a dense structure.

The thickness of the transition layer is 20 μm to 200 μm; the thickness of the transition layer is 100 μm to 160 μm.

The component of the transition layer includes aluminosilicate glass and/or barium silicate glass;
and/or, the component of the porous substrate includes soda-lime silicate glass and/or borosilicate glass.

The porosity of the porous substrate is 20% to 90%.

The porosity of the porous substrate is 40% to 80%.

The average pore size of the porous substrate is 10 μm to 300 μm.

The average pore size of the porous substrate is 15 μm to 60 μm.

The average pore size of the porous substrate is 20 μm to 50 μm.

Pores of the porous substrate include at least one of ordered straight through pores, ordered tortuous through pores, or disordered pores.

The heating element is a metal mesh or a metal sheet;
and/or, the material of the heating element is selected from at least one of iron-based alloy materials or nickel-based alloy materials;

The heating element is selected from at least one of stainless steel or iron-chromium-aluminum alloy.

The shape of the heating element is rhombus or honeycomb.

The thickness of the heating element is 20 μm to 200 μm.

The thickness of the heating element is 50 μm to 120 μm.

At least part of the surface of the heating element has a micro-nano structure.

The surface roughness Ra of the heating element having the micro-nano structure is 100 nm to 300 nm.

The ratio of an area where the transition layer fills and/or covers the porous substrate to an area where the heating element covers the porous substrate is (0.8-1.2): 1.

The ratio of the area where the transition layer fills and/or covers the porous substrate to the area where the heating element covers the porous substrate is 1:1.

The present disclosure provides an atomizer, including the atomization core described above.

The present disclosure further provides an electronic atomization device, including the atomizer described above and a power supply component.

The present disclosure has the following beneficial effects:

The atomization core provided in the present disclosure includes a porous substrate, a heating element, and a transition layer bonded between the porous substrate and the heating element; and the transition layer contains an inorganic material component. The transition layer is arranged between the heating element and the porous substrate, and the two are bonded and fixed through the transition layer. The obtained atomization core has an excellent service life and avoids problems such as dry heating.

### BRIEF DESCRIPTION OF THE DRAWINGS

To describe the technical solutions in examples of the present disclosure or in the prior art more clearly, the following briefly introduces the accompanying drawings required for describing the examples or the prior art. Obviously, the accompanying drawings in the following description show merely some examples of the present disclosure, and a person of ordinary skill in the art may still derive other drawings from these accompanying drawings without creative efforts.

FIG. 1 is a schematic cross-sectional view of an atomization core provided in Example 1 of the present disclosure;

FIG. 2 is a cross-sectional SEM image of the atomization core provided in Example 1 of the present disclosure;

FIG. 3 is a schematic view showing the shape of a heating element on the atomization core provided in the present disclosure;

FIG. 4 is a photograph of the atomization core in Example 1 of the present disclosure;

FIG. 5 is an SEM image of an atomization surface of the atomization core provided in Example 1 of the present disclosure;

FIG. 6 is a comparison graph of temperature rise curves of a heating element for various samples during a temperature field test in Example 1 of the present disclosure; and

FIG. 7 is an area distribution diagram of an infrared temperature field for various samples during a temperature field test in Example 1 of the present disclosure.

### DESCRIPTION OF REFERENCE NUMERALS

1—porous substrate; 2—heating element; and 3—transition layer.

### DETAILED DESCRIPTION

The following examples are provided to facilitate a further and better understanding of the present disclosure, are not limited to the described preferred examples, and do not limit the content and scope of protection of the present disclosure. Any product identical or similar to the present disclosure, obtained by anyone based on the inspiration of the present disclosure or by combining features of the present disclosure with features of other prior art, shall fall within the scope of protection of the present disclosure.

For those examples in which specific experimental steps or conditions are not specified, the operations or conditions of the conventional experimental steps described in the documents in the art can be carried out. For those reagents or instruments for which the manufacturers are not specified, they are all conventional reagent products that can be obtained through commercially available channels.

Conventional electronic atomization devices typically utilize an atomization core to atomize an atomization substance. Specifically, the atomization core generally includes a porous substrate and a heating element. In the prior art, porous ceramic is commonly used as the porous substrate, and a conductive metal material is used as the heating element. The conductive metal heating element is usually fixed by being embedded into the porous ceramic substrate. The inventors have found that when using the aforementioned method to fix heating elements such as heating wires, heating meshes, or heating sheets, only a few points embedded into the porous substrate are in close contact with the substrate. Most of the other parts of the heating element are not in tight contact with the porous substrate, resulting in a gap between the porous substrate and the heating element. This relatively loose contact method further leads to the following problems: first, the thermal resistance between the heating element and the porous substrate is large. Due to the low thermal conductivity of air and the atomization substance, the heat of the heating element concentrates on the heating element itself, making it difficult to transfer and disperse the heat across the entire atomization surface. This easily causes localized high temperatures, leading to dry heating. Simultaneously, localized high temperatures accelerate the formation of carbon deposits, affecting the flavor and service life of the atomization core. Second, since most of the heating element is not in tight contact with the porous substrate, its deformation is unconstrained. Under thermal shock, the deformation across different parts of the heating element becomes uneven, easily causing excessive local deformation, resulting in problems such as warping or fracture, which affects the service life. Third, the gap between the heating element and the porous substrate suffers from poor consistency. Due to the sintering and curing process, the porous substrate has a specific shrinkage rate, resulting in poor gap consistency. An excessively large gap leads to insufficient liquid supply to the heating element, causing problems such as dry heating. In particular, the poor consistency results in significant variation in aerosol output, leading to inconsistent flavor and adversely affecting the consumer experience. Consequently, the atomization core obtained by this method suffers from problems such as short service life and tendency to cause dry heating.

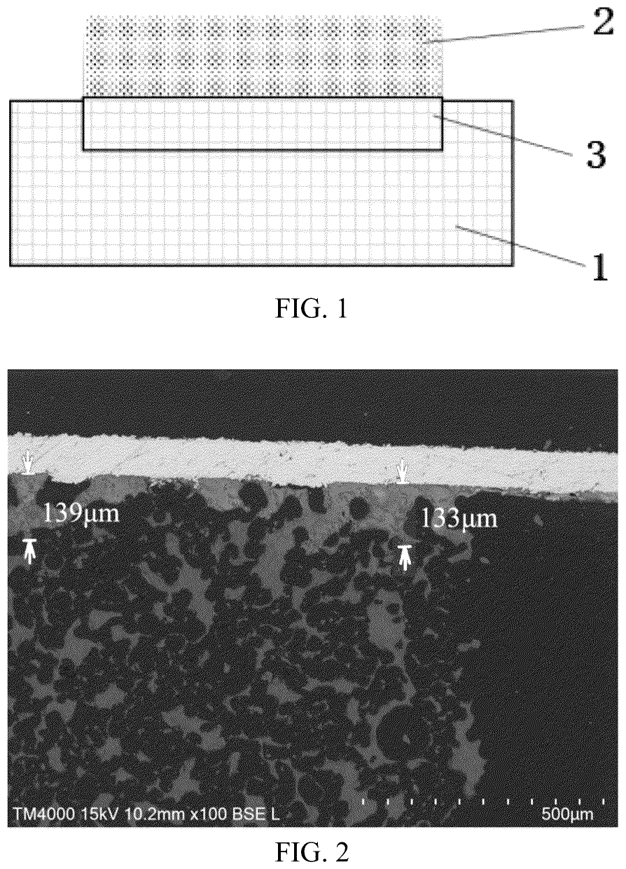

Based on the above analysis, the present disclosure provides an atomization core to solve or alleviate the aforementioned specific technical problems. As shown in FIG. 1, the atomization core includes a porous substrate 1, a heating element 2, and a transition layer 3 bonded between the porous substrate and the heating element. The transition layer contains an inorganic material component. For ease of description, in the present disclosure, the surface of the porous substrate provided with the transition layer and the heating element is referred to as an atomization surface. A liquid atomization substance is guided to the atomization surface under capillary action for atomization. A surface opposite to the atomization surface is referred to as a liquid absorbing surface, which is used for absorbing the liquid atomization substance. A distance between the atomization surface and the liquid absorbing surface is equal to the thickness of the porous substrate. Since the transition layer is arranged between the heating element and the porous substrate, and the two are bonded and fixed through the transition layer, there is no gap or interval therebetween. Furthermore, as the transition layer contains an inorganic material component whose thermal conductivity is significantly higher than that of air, the following effects are achieved: first, heat from the heating element is quickly and efficiently transferred to the atomization surface of the porous substrate, transferring and dispersing the heat across the entire atomization surface, thereby avoiding localized high temperatures and preventing dry heating. Second, the bonding of the heating element by the transition layer imposes constraints on its deformation under thermal shock. Simultaneously, as the temperature across the atomization surface is more uniform, the deformation of various parts of the heating element tends to be consistent, avoiding occurrences such as warping or fracture and extending its service life. Third, since there is no gap between the porous substrate and the heating element in the atomization core of the present disclosure, the e-liquid film on the atomization surface can be distributed more uniformly, supplying liquid to the heating element more efficiently and avoiding insufficient liquid supply. Therefore, the atomization core of the present disclosure simultaneously solves the aforementioned problems of the prior art, improves the service life of the atomization core, and avoids problems such as dry heating.

In an aspect, the content of the inorganic material component in the transition layer is greater than 80 wt %. The content of the inorganic material component in the transition layer is greater than 90 wt %. The content of the inorganic material component in the transition layer is 100 wt %. It can be understood that since inorganic material systems generally possess higher thermal conductivity, thermal stability, and safety, the higher the content of the inorganic material component in the transition layer, the better the resultant effect.

In an aspect, the transition layer contains a glassy phase. It can be understood that glass is an amorphous inorganic non-metallic material, and the glass phase refers to a solid phase having the aforementioned amorphous, inorganic, and non-metallic characteristics. In the present disclosure, the glass phase may be formed by sintering a paste containing glass powder. The advantage of the glass phase lies in that during the sintering and forming process, it possesses appropriate fluidity and adhesive property, which facilitates good contact and bonding with the contact surface of the heating element and better filling the gap between the heating element and the porous substrate.

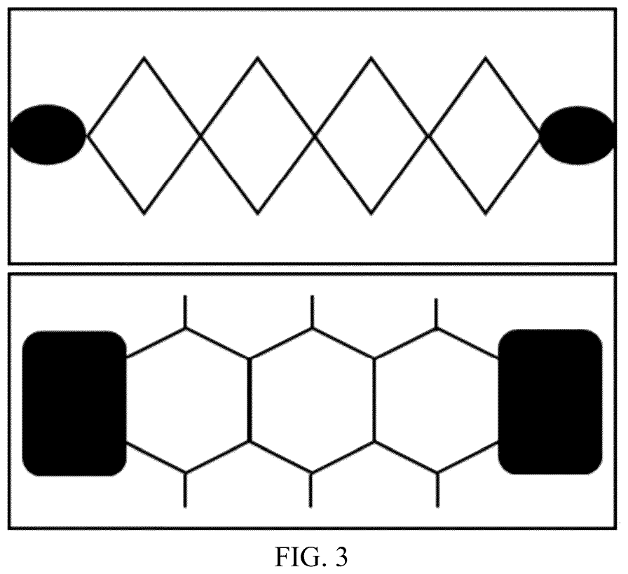

As shown in FIG. 1 and FIG. 2, in an aspect, the transition layer is a dense structure. The dense structure has a higher thermal conductivity coefficient and better mechanical properties, which can enhance the bonding strength between the heating element and the transition layer.

In an aspect, the transition layer at least partially fills and/or covers the porous substrate. Specifically, as shown in FIG. 2, the transition layer may fill part of pores of the porous substrate, forming an embedded structure. The transition layer is used for bonding and fixing the metal heating element onto the surface of the porous substrate. The embedded structure formed by the transition layer and the porous substrate can effectively increase the bonding strength between the two, prevent warping of the heating element, and improve the service life. Based on this embedded structure, the transition layer is almost impossible to separate from the porous substrate without destroying the porous substrate. Further, the transition layer is non-porous and densely fills the space between the heating element and the porous substrate, thereby also improving thermal conduction, rapidly transferring heat into the porous substrate for good atomization effect, and reducing the probability of dry heating. Further, during sintering and curing, the porous substrate and the transition layer embedded in the porous substrate achieve interlocking due to appropriate fluidity, further enhancing the bonding strength and further ensuring the service life. Specifically, the transition layer may also cover the porous substrate. This manifests as a portion of the transition layer merely covering the surface of the porous substrate, without infiltrating into the pores for filling. The portion of the transition layer that does not infiltrate into the pores can, on its own, achieve the bonding and fixing of the porous substrate and the heating element, or it can cooperate with the transition layer filling the pores to jointly achieve the bonding and fixing of the porous substrate and the heating element. It can be understood that the transition layer filling the porous substrate will, to some extent, reduce the porosity of the porous substrate in that area, as well as decrease the proportion of open pores in that area, consequently affecting the liquid guiding effect in that area. The transition layer covering the porous substrate will, to some extent, decrease the proportion of open pores in that area, also affecting the liquid guiding effect in that area.

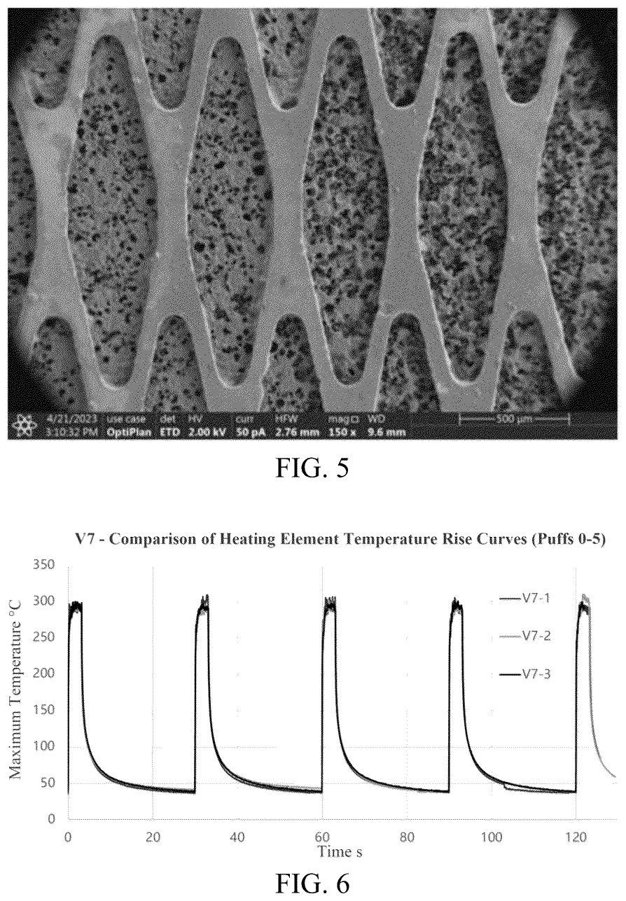

In an aspect, the transition layer at least partially fills and/or covers an area where the heating element is in contact with the porous substrate. This achieves a tight bond between the heating element and the porous substrate. At the same time, it can be understood that the transition layer having a dense structure, when filling and/or covering the porous substrate, will reduce the porosity of the porous substrate and diminish the liquid guiding effect in that portion. Therefore, filling only the area where the heating element contacts the porous substrate correspondingly can ensure a high liquid guiding effect in other parts of the porous substrate, i.e., reducing the impact on the porosity and open pore ratio of the atomization surface. Therefore, in an aspect, an area on the porous substrate not in contact with the heating element is at least partially not filled and/or covered by the transition layer, so as to achieve a good liquid guiding effect. It can be understood that, ideally, within the planar direction of the atomization surface of the porous substrate, the transition layer fills and/or covers the area of the porous substrate corresponding to the heating element, while other areas are not filled and/or covered by the transition layer. More preferably, the ratio of an area where the transition layer fills and/or covers the porous substrate to an area where the heating element covers the porous substrate is (0.8-1.2):1. Within this range, both strength and liquid guiding effect are achieved; The ratio of the area where the transition layer fills and/or covers the porous substrate to the area where the heating element covers the porous substrate is 1:1. As shown in FIG. 5, in this aspect, it can be seen that the area of the porous substrate outside the heating element has a good pore structure, enabling a good liquid guiding effect in this area.

In an aspect, the thickness of the transition layer is 20 μm to 200 μm. The thickness of the transition layer is 100 μm to 160 μm. For example, the thickness of the transition layer may be 100 μm, 102 μm, 105 μm, 107 μm, 110 μm, 112 μm, 115 μm, 117 μm, 120 μm, 122 μm, 125 μm, 127 μm, 130 μm, 132 μm, 135 μm, 137 μm, 140 μm, 142 μm, 145 μm, 147 μm, 150 μm, 152 μm, 155 μm, 157 μm, or 160 μm. Filling of the porous substrate by the transition layer in the thickness direction also affects liquid guiding in the thickness direction to some extent. Therefore, the selection of the thickness of the transition layer needs to consider that it will neither affect the normal heating and atomization function of the atomization core, nor reduce the overall bonding strength. The aforementioned thickness range ensures good bonding strength and liquid guiding effect.

In an aspect, the thickness of the transition layer may be non-uniform; and the maximum thickness of the non-uniform transition layer is 60 μm to 200 μm. For example, the maximum thickness may be 60 μm, 70 μm, 80 μm, 90 μm, 100 μm, 110 μm, 120 μm, 130 μm, 140 μm, 150 μm, 160 μm, 170 μm, 180 μm, 190 μm, or 200 μm. In some aspects, due to the uneven surface of the porous substrate, the thickness at a portion with the minimum thickness of the transition layer may be much smaller than that at a portion with the maximum thickness. For example, the minimum thickness of the transition layer may be 0.1 μm to 30 μm. Generally, the better the surface flatness of the porous substrate, the better the thickness uniformity of the transition layer.

In an aspect, the raw material of the transition layer in the present application employs glass powder, which is conventional glass powder in the art and is commercially available. The softening point temperature of the glass in the transition layer is 400° C. to 1100° C. It can be understood that silicon dioxide is the main component of the transition layer. Other components of the transition layer include aluminum oxide, calcium oxide, barium oxide, zinc oxide, and the like, which are used to adjust the softening point temperature of the glass, thereby improving the sintering and curing temperature and the fluidity of the glass. It should be noted that the softening point temperature should not be too low. It should at least be greater than the upper limit of the possible maximum operating temperature range of the atomization core. At the same time, the softening point temperature of the glass in the transition layer should not be too high. It should at least be less than the forming temperature or the damage temperature of the porous substrate, to avoid affecting the structural stability of the porous substrate. Further, the component of the transition layer includes aluminosilicate glass and/or barium silicate glass.

In an aspect, the porosity of the porous substrate is 20% to 90%. The porosity of the porous substrate is 40% to 80%. For example, the porosity of the porous substrate may be 40%, 42%, 45%, 46%, 48%, 50%, 51%, 53%, 56%, 58%, 59%, 60%, 61%, 63%, 65%, 67%, 69%, 70%, 71%, 72%, 74%, 75%, 76%, 77%, 78%, 79%, or 80%.

In an aspect, the average pore size of the porous substrate is 10 μm to 300 μm. The average pore size of the porous substrate is 15 μm to 60 μm. The average pore size of the porous substrate is 20 μm to 50 μm. For example, the average pore size of the porous substrate may be 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 45 μm, 46 μm, 47 μm, 48 μm, 49 μm, or 50 μm.

In an aspect, pores of the porous substrate include at least one of ordered straight through pores, ordered tortuous through pores, or disordered pores. In an aspect, the porous substrate contains a glassy phase and/or contains a ceramic phase.

The present application does not specifically limit the porous substrate. The porous substrate may be a ceramic porous substrate primarily composed of a ceramic component, a glass porous substrate primarily composed of a glass component, or a glass-ceramic porous substrate. The porous substrate has an internal porous structure, utilizing capillary action to achieve liquid guiding. The glass softening point temperature within the porous substrate is 600° C. to 1200° C.; The porous substrate is a glass-ceramic porous substrate. Further, the component of the glass-ceramic porous substrate includes soda-lime silicate glass and/or borosilicate glass.

In an aspect, both the transition layer and the porous substrate contain a glassy phase. The matching of components between the porous substrate and the transition layer helps improve bonding strength, reduce warping, and increase service life. At the same time, similar components enable the porous substrate and the transition layer to have substantially consistent coefficients of thermal expansion, which can enhance service life under thermal shock during application of the atomization core.

In an aspect, the raw material component of the porous substrate includes glass powder. Further, the components of the glass powder include silicon oxide, boron oxide, sodium oxide, calcium oxide, and aluminum oxide.

In an aspect, the porous substrate, the transition layer, and the heating element are bonded together through sintering and curing. The sintering and curing temperature thereof is 800° C. to 1100° C., and the sintering and curing time is 8 min to 12 min. At this curing temperature, the softening point of the glass is reached. Particularly when both the porous substrate and the transition layer have a glass phase, sintering at a relatively high temperature allows both the porous substrate and the transition layer to exhibit good fluidity and interlock with each other. Consequently, the bonding strength between the porous substrate and the transition layer is further enhanced, reducing warping and improving service life.

The present disclosure does not specifically limit the specific preparation method or pore-forming method of the porous substrate. Typically, and without limitation, in an aspect, a preparation method for the porous substrate includes the following steps:
1) mixing raw material glass bubbles with a binder, a slip agent, and water, and performing extrusion molding to obtain a blank; and
2) subjecting the blank from step 1) to a first sintering, a second sintering, and a third sintering, to obtain a porous glass-ceramic substrate.

In step 1): the binder may be selected from organic binders; specifically, the binder is selected from at least one of methyl cellulose, hydroxyethyl cellulose, or hydroxypropyl methyl cellulose; the slip agent may be an aliphatic hydrocarbon slip agent, such as paraffin wax or a metal stearate; specifically, the slip agent is sodium stearate.

In step 1), the pressure for the extrusion molding is 1 bar to 30 bar. During the extrusion molding process, most of glass bubbles remain unbroken and maintain their intact spherical shape as individual glass bubbles. Therefore, the pressure for the extrusion molding may be appropriately adjusted according to the compressive strength of the selected glass bubbles.

In step 2), the first temperature of the first sintering is at least 200° C., for example, 300° C. to 400° C., and/or the first dwell time is at least 1 minute, for example, 1 hour to 10 hours. During the sintering at this temperature, substances such as solvent and binder in the blank are removed. The second temperature of the second sintering is greater than 400° C. and less than the softening point of the glass of the glass bubbles, for example, 500° C., 600° C., 700° C., etc.; the second dwell time is at least 1 minute, for example, 1 hour to 10 hours. The second temperature is higher than 400° C. and lower than the softening point of the glass of the glass bubbles. The purpose is to maintain the original shape of the blank unchanged. At the same time, since the temperature already exceeds 400° C., the glass components in the glass bubbles begin to undergo phase transformation. The disordered glass phase partially crystallizes into a crystalline phase within this temperature range, transforming the glass bubbles into glass-ceramic bubbles or increasing the proportion of the crystalline phase in the glass bubbles. Simultaneously, due to this transformation, some glass bubbles begin to rupture, having at least one opening. Therefore, the sintering time within this temperature range can be appropriately adjusted to regulate the crystallinity of the porous glass-ceramic. It can be understood that the raw material glass bubbles themselves may also contain a proportion of crystalline phase, which can shorten the sintering time in this process.

The third temperature of the third sintering is greater than the softening point of the glass. Specifically, the softening point temperature of the glass is less than 900° C. The third dwell time may be at least 1 minute, for example, 1 hour to 10 hours. At this temperature, the glass component exhibits fluidity. Therefore, adjacent glass-ceramic bubbles directly bond to each other, causing the glass-ceramic bubbles to bond into an integrated porous glass-ceramic substrate. Simultaneously, since the glass-ceramic bubbles still contain a crystalline phase component, the crystalline phase component acts as a skeleton, preventing their morphology from collapsing and allowing them to remain substantially intact. In addition, the glass-ceramic bubbles further crack to form numerous openings. The openings interconnect to form pores, which extend through the porous glass-ceramic substrate and reach the surface of the porous glass-ceramic substrate.

The third temperature is higher than the softening point of the glass of the glass bubbles. Heating the glass-ceramic bubbles to at least the softening temperature of the amorphous glass causes most of the glass-ceramic bubbles to develop openings due to gas expansion inside the bubbles. Concurrently, the heating causes adjacent glass-ceramic bubbles to sinter together, forming bonds. Overall, the bonded, open glass-ceramic bubbles form the pores of the porous glass-ceramic substrate. When applied in atomizers or electronic atomization devices, this can effectively improve the atomization efficiency and liquid guiding effect.

In an aspect, the mass ratio of the glass bubbles to the binder to the slip agent to water is (100-200):(10-50):(1-10):(45-150).

In an aspect, the glass component in the glass bubbles may be soda-lime silicate glass, borosilicate glass, or other glass. Specifically, the glass component may include: Si: 40-44 wt %, 0:45-52 wt %, Na: 2-5 wt %, Ca: 2-6 wt %, Mg: 0.1-0.5 wt %, Al: 0.1-0.5 wt %; or may include: SiO₂: 74-85 wt %, CaO: 6.5-10 wt %, B₂O₃: 5-9 wt %, Al₂O₃: 0.4-2 wt %, Fe₂O₃: 0.01-1 wt %, Na₂O: 1-3 wt %, K₂: 0.1-0.5 wt %.

In an aspect, step 1) further includes adding a pore-forming agent. The pore-forming agent is selected from at least one of starch, polymethyl methacrylate (PMMA), polystyrene (PS), or graphite. The average particle size range of the pore-forming agent may be 1 μm to 150 μm. It can be understood that the addition of the pore-forming agent can further increase the porosity of the porous glass-ceramic substrate while ensuring the strength of the raw material glass bubbles.

In an aspect, step 1) further includes a second inorganic material. The second inorganic material may be at least one of clay, talc, silicon dioxide, or aluminum oxide. The melting point or softening point of the aforementioned materials is higher than the softening point of the glass in the glass bubbles.

In an aspect, the mass ratio of the glass bubbles to the binder to the slip agent to water to the pore-forming agent to the second inorganic material is (100-200):(10-50):(1-10):(45-150):(0-70):(0-9).

The porous substrate obtained through the aforementioned preparation method is a porous glass-ceramic substrate (denoted as a first porous substrate), including multiple glass-ceramic bubbles, where adjacent glass-ceramic bubbles are directly bonded to each other through sintering; at least some of the glass-ceramic bubbles have openings. Cavities inside the glass-ceramic bubbles having the openings are interconnected through the openings to form pores. The pores extend through the porous glass-ceramic substrate and reach the surface of the porous glass-ceramic substrate. In the present disclosure, pores with an extending direction of the pore structure being disordered are referred to as disordered pores. The pores of the porous substrate include disordered pores, and the porous substrate is a glass-ceramic porous substrate. That is, the porous substrate contains a glassy phase and a ceramic phase. In the present disclosure, a porous substrate having the aforementioned structure is designated as a first porous substrate.

In an aspect, a preparation method for the porous substrate includes the following steps:
1) stacking ablatable organic material wire meshes to form a three-dimensional organic template; and
2) filling a ceramic paste into the three-dimensional organic template, followed by drying, debinding, and sintering to obtain the ceramic substrate.

The preparation method for the ceramic paste includes the following steps: mixing silicon dioxide, potassium feldspar, an organic monomer, a cross-linking agent, and water, adjusting the pH, and performing grinding to obtain the ceramic paste.

After ablation of the three-dimensional organic template, three-dimensional pores are formed within the ceramic substrate.

The material of the organic material wire mesh is an organic polymer material; and/or, the organic polymer material includes one of a polyamide material or polyester material.

The material of the organic material wire mesh is selected from at least one of nylon or polyethylene terephthalate.

In step 1), the organic material wire mesh is formed by interweaving organic material filaments as warp and weft threads.

The weaving method may be plain weave, and the organic material filaments may be woven by alternating 1 warp and 1 weft.

The diameters of the warp and weft threads may be the same or different, within a diameter range of 10 μm to 200 μm.

The diameter of the warp thread is 10 μm to 80 μm.

The diameter of the weft thread is 10 μm to 150 μm.

The spacing between adjacent warp threads is 20 μm to 300 μm, and the spacing between adjacent weft threads is 20 μm to 300 μm.

The spacing between adjacent warp threads is 20 μm to 150 μm, and the spacing between adjacent weft threads is 20 μm to 150 μm.

The method further includes a step of fixing the organic material wire mesh using an outer frame.

The outer frame is a metal outer frame.

In step 1), the number of layers after stacking the organic material wire mesh is 50 to 500, and the thickness after stacking is 2 mm to 10 mm. There may be a spacing between adjacent layers, for example, an interlayer spacing may be 10 μm to 100 μm.

Step 1) further includes, after stacking the organic material wire mesh, a step of fixing the layered mesh with a fixture. In step 2), the preparation method for the ceramic paste includes the following steps: mixing ceramic powder, an organic monomer, a cross-linking agent, and water, adjusting the pH, and performing grinding to obtain the ceramic paste.

The mass ratio of the ceramic powder to the organic monomer to the cross-linking agent to water is (60-80):(2-5):(0.2-2):(15-40); and/or,
the organic monomer is acrylamide, and the cross-linking agent is N,N′-methylenebisacrylamide.

The preparation method for the ceramic paste further includes a step of adding an initiator and a catalyst to the ceramic paste.

The mass ratio of the organic monomer to the initiator to the catalyst is (1-10):(0.1-1):(0.1-1);
the initiator is ammonium persulfate;
the catalyst is tetramethylethylenediamine.

The ceramic powder includes silicon dioxide and a sintering additive;
the mass ratio of the silicon dioxide to the sintering additive is (55-95):(5-30).

The sintering additive is potassium feldspar.

The rotation speed for the grinding is 50 rpm to 100 rpm, and the grinding time is 24 h to 36 h; and/or,
the pH value adjusted during the preparation of the ceramic paste is 8 to 10; and/or,
an agent for adjusting the pH is ammonia water or tetramethylammonium hydroxide.

The grinding may be ball milling.

The mass concentration of ammonia in the ammonia water is 5% to 39%.

In step 2), the drying temperature is 25° C. to 60° C., and the drying time is 24 h to 120 h; and/or,
in step 2), the debinding temperature is 450° C. to 500° C., and the debinding time is 1800 min to 2400 min; and/or,
in step 2), the sintering temperature is 1150° C. to 1200° C., and the sintering time is 1200 min to 1800 min.

The ambient humidity for the drying step is 30% to 80%. The ambient humidity refers to the relative humidity of the environment. Maintaining the ambient humidity at 30% to 80% helps prevent the ceramic substrate from cracking during the drying process.

According to the above method, by constructing a three-dimensional organic template, casting the ceramic paste, and performing debinding and sintering, a dense ceramic with an interconnected through pore structure is formed (denoted as a second porous substrate). This ceramic porous substrate has a longitudinal through pore structure extending vertically through upper and lower surfaces (the liquid absorbing surface and the atomization surface) of the ceramic substrate, and transverse curved through pore structures connected to the longitudinal through pores.

Similarly, in an aspect, the three-dimensional organic template in the aforementioned preparation process is replaced with an organic template extending in a two-dimensional direction, i.e., a fiber template including only organic material filaments that penetrate the upper and lower surfaces (the liquid absorbing surface and the atomization surface) of the ceramic substrate. A ceramic porous substrate is prepared using a substantially similar scheme. This ceramic porous substrate has a longitudinal through pore structure extending vertically through the upper and lower surfaces (the liquid absorbing surface and the atomization surface) of the ceramic substrate. Since the fibers of the organic template in the above scheme may be in a straight-through state, the through pore structure may be ordered straight through pores.

In an aspect, ordered straight through pores or ordered tortuous through pores may also be prepared on a dense substrate by means of laser drilling or etching. The dense substrate may be a ceramic substrate or a glass substrate. The aforementioned preparation methods belong to the prior art and will not be repeated here.

In summary, in the present disclosure, pores in which the extending directions of the pores are substantially consistent is referred to as ordered pores. The porous substrate with the porous structure includes ordered pores extending along the thickness direction, as well as ordered pores extending parallel to the atomization surface. It can be understood that in an aspect, it may include only ordered pores extending along the thickness direction. At the same time, since the ordered pores penetrate the entire porous substrate and the through pores may be in a vertical or curved state, they are also referred to in the present disclosure as ordered straight through pores or ordered tortuous through pores. Therefore, in some examples, the pores of the porous substrate include ordered straight through pores or ordered tortuous through pores. Depending on the raw materials used, the material of the porous substrate may be ceramic and/or glass. In the present disclosure, a porous substrate having such a structure is designated as a second porous substrate.

Typically, and without limitation, in an aspect, a preparation method for the porous substrate includes the following step: preparing by molding using glass, fiber material, and pore-forming agent powder.

Generally, there are five close-packing arrangements for equal-diameter spheres: simple cubic close-packing, with coordination number of 6 and packing density of 52.4%; orthorhombus close-packing, with coordination number of 8 and packing density 60.5%; tetragonal close-packing, with coordination number of 10 and packing density of 69.8%; face-centered cubic close-packing and hexagonal close-packing, with coordination number of 12 and packing density of 74.2%. To obtain the porous glass material constructed with multi-directionally interconnected pores, the pore-forming agent is designed to be added at a volume ratio corresponding to close-packing. That is, the volume of the pore-forming agent accounts for 60% to 75% of the total material volume. The volume of the pore-forming agent accounts for 70% to 75% of the total volume.

The glass powder acts as a bonding skeleton. Fine glass powder can be uniformly dispersed throughout the system, resulting in more uniform pore distribution and better connectivity in the sintered porous glass. Simultaneously, fine glass powder can shorten the sintering time and reduce glass flow at high temperatures, thereby improving efficiency while increasing the uniformity of the overall material. In this case, the fiber component serves as a skeleton support. For preparing a porous material with a pore size of 70-80 μm and a pore throat of 30-40 μm, a fiber skeleton providing support may be 70-150 μm. Generally, small-sized fibers or ceramic particles do not affect the overall scaffold structure. After sintering, the small-sized fibers or ceramic particles are enveloped by the glass powder and aggregate at fiber bonding sites (pore-forming agent interstices), forming support endpoints.

The porous glass includes a skeleton and multi-directionally interconnected pores. The skeleton includes a fiber skeleton forming a scaffold structure and a glass covering bonding layer providing bonding and stabilization. The fiber skeleton has a length of 70-150 μm, a skeleton diameter of 15-45 μm, and a weight percentage range of 12-45%. The material of the fiber skeleton is a high-temperature-resistant ceramic fiber material, including alumina, mullite, zirconia, etc. The fiber diameter is 10-40 μm, and the length is 10-150 μm. The effective fiber length forming the scaffold structure is 70-150 μm. The glass covering bonding layer includes a glass material and fibers or ceramic powder that do not form the scaffold structure, with a weight percentage range of 55-88%.

The preparation method for the porous glass material generally includes: mixing glass powder, a fiber component, and a pore-forming agent, preparing a green compact, and performing binder removal, sintering, and other steps.

The fiber component has a diameter of 3-30 μm and a length of 20-500 μm.

The fiber component has a diameter of 10-25 μm and a length of 20-150 μm.

The fiber component has an aspect ratio of 1 to 10; for fibers with a length of 50 μm to 150 μm, the aspect ratio is 2 to 5;
and/or, within the fiber component, fibers with a length above 50 μm account for at least 25%; The proportion is above 40%; The proportion is 40% to 100%.

Based on the total mass of the glass powder and the fiber component, the glass powder accounts for 40% to 62%, and the fiber component accounts for 38% to 60%;
and/or, the amount of the pore-forming agent is 0.3 to 2.5 times the total mass of the glass powder and the fiber component.

The green compact is prepared by any one of tape casting, injection molding, dry pressing, or gel-casting processes.

The aforementioned processes for preparing the green compact are known in the field, and corresponding processing aids may be added and used according to the selected process. Typically, and without limitation, steps of the injection molding process are approximately as follows: subjecting the blended material with injection molding additives (such as paraffin wax, polyethylene, a dispersant, and the like) to high-temperature internal mixing until uniform, and then performing injection molding to form a green compact of a specified shape. The amount of the injection molding additives is 5% to 50% of the total mass of the blended material, and the dispersion aid is selected from dibutyl phthalate.

And/or, the binder removal temperature is 200° C. to 800° C., and the binder removal time is 5 h to 50 h. The binder removal temperature is 200° C. to 350° C. And/or, the sintering temperature is 900° C. to 1250° C. or 1180° C. to 1320° C., and the sintering time is 10 min to 180 min. The preparation method for the porous glass satisfies at least one of the following (1) to (5):
(1) the softening temperature of the glass powder is 600° C. to 1200° C.; the softening point of the selected fiber raw material needs to be above the sintering temperature in the preparation method to function as a skeleton;
(2) the particle size of the glass powder is less than 10 μm. The particle size is less than 3000 mesh;
(3) the fiber component is at least one of silicon carbide fiber, silicon nitride fiber, aluminum silicate fiber, quartz fiber, mullite fiber, alumina fiber, hydroxyapatite fiber, or zirconia fiber;
(4) the material of the pore-forming agent is one or a mixture of materials that can decompose, volatilize, or burn at high temperatures, such as carbon powder, polystyrene, polymethyl methacrylate, polylactic acid, polyvinyl alcohol, polyethylene terephthalate, engineering plastics, starch, cellulose, wood chips, graphite powder, and the like;
(5) the particle size of the pore-forming agent is 10 μm to 300 μm. The average particle size of the pore-forming agent is 80 μm. The proportion of pore-forming agents with different diameters may be adjusted to obtain porous glass material with better connectivity.

To obtain the porous glass with this specific pore structure, the following pretreatment is performed on the glass raw material and fiber material:
(1) The raw glass powder has a particle size less than 10 μm. glass powder with a particle size of 3000 mesh or finer is used. To obtain glass powder with a uniform particle size, commercially available glass powder may be used, with ethanol as a solvent, and ground in a high-energy planetary ball mill at a rotation speed of 200 r/min to 500 r/min for 3-5 hours, and then dried and sieved for use.
(2) Fibers may be high-temperature resistant fibers such as mullite fiber, zirconia fiber, or alumina fiber. In this case, mullite fiber may be selected, with a fiber diameter of 10-25 μm, a length of less than 100 μm, and a fiber aspect ratio of 1-10. Generally, commercially available chopped fibers of 2 mm to 5 mm are first crushed to below 0.5 mm using a crusher followed by high-energy planetary ball milling for 2-8 hours with ethanol as a solvent and stearic acid as a grinding aid at a ball milling speed of 100 r/min to 400 r/min; ball milling at 300 r/min for 6 hours. The ball-milled fibers are then washed with ethanol, dried, and sieved through a 100-mesh sieve to obtain the target fibers.

The porous glass with multi-directionally interconnected pores is prepared by an injection molding method, and its preparation method is as follows:

Glass, fibers, and the pore-forming agent are batched according to a specific ratio, and mixed in a three-dimensional mixer for 2 hours until uniform. The pore-forming agent is a spherical pore-forming agent, with a particle size of 10-300 μm. The pore-forming agent has a diameter of 80 μm, or the pore-forming agent has a diameter of 50 μm. The mixed material is then subjected to high-temperature internal mixing with injection molding additives (paraffin wax, polyethylene, and a dispersant) in a mixer until uniform, and subsequently injection molded to form a green compact of a specified shape. The temperature is raised to 200° C. over 200 minutes, then further raised to 500° C. at a rate of 0.5° C. per minute, with 2-hour holding periods set at 240° C., 280° C., 300° C., and 350° C. respectively. Afterwards, the temperature is raised to 1180° C. to 1320° C. at a rate of 5° C. per minute, held for 30 minutes, and then naturally cooled to room temperature. Generally, an optimal binder removal process may be determined based on the thermogravimetric curve of the pore-forming agent.

Alternatively, the porous glass with multi-directionally interconnected pores may be obtained by directly close-packing hollow glass microspheres, followed by sintering. Generally, the selected hollow glass microspheres have a particle size of 50-120 μm; The hollow glass microspheres have a particle size of 80-100 μm. Generally, a gel-casting method may be used to prepare the porous substrate. First, the hollow glass microspheres are heated to 80° C., then added to an 80° C. sol solution, stirred, and deaerated. The mixture is injected into a mold under a pressure of 5 MPa, allowed to cool to form a gel green body. The green body is dried at 50° C., then sintered at 1000° C. for 30 minutes, and naturally cooled to obtain a porous glass substrate.

Through the aforementioned preparation method, a porous glass with multi-directionally interconnected pores (denoted as a third porous substrate) is obtained, including a skeleton and multi-directionally interconnected pores. The multi-directionally interconnected pores are spherical pores, each interconnected to at least 6 surrounding pores. As described above, the pores of the porous substrate are primarily disordered pores. The porous substrate mainly contains a glassy phase.

In an aspect, the heating element is a metal mesh or a metal sheet. It can be understood that the metal mesh or metal sheet itself has a dense structure. The transition layer possesses a bonding effect during high-temperature sintering and has good bonding with the dense-structured metal mesh or metal sheet, thereby enhancing the overall bonding strength of the heating element, the transition layer, and the porous substrate, preventing warping, improving the service life of the atomization core, and solving the problem of dry heating.

In an aspect, at least part of the surface of the heating element has a micro-nano structure. The micro-nano structure is a microstructure of a specific size provided on the surface of the heating element, typically with a size range below the micrometer level. Providing the micro-nano structure on the contact surface with the transition layer can improve the bonding performance between the transition layer and the heating element. Providing the micro-nano structure on the atomization surface of the heating element can enhance the mouthfeel of the atomization substance. A formation method of the micro-nano structure may be selected from at least one of sandblasting, laser etching, or chemical etching. The surface roughness (Ra) of the heating element having the micro-nano structure is 100 nm to 300 nm.

In an aspect, the material of the heating element is selected from at least one of iron-based alloy materials or nickel-based alloy materials. Further, the material of the heating element is selected from at least one of stainless steel or iron-chromium-aluminum alloy.

In an aspect, the thickness of the heating element is 20 μm to 200 μm; The thickness of the heating element is 50 μm to 120 μm. For example, the thickness of the heating element may be selected from 50 μm, 55 μm, 60 μm, 65 μm, 70 μm, 75 μm, 80 μm, 85 μm, 90 μm, 95 μm, 100 μm, 105 μm, 110 μm, 112 μm, 115 μm, or 120 μm.

For example, stainless steel with low resistivity may be selected in the present disclosure, generally having a thickness of 20-200 μm and a line width of 60-80 μm. Iron-chromium-aluminum alloy may also be selected, having a thickness of 50-120 μm and a line width of 60-100 μm.

In an aspect, the resistance of the heating element is 0.5 Ω to 1.5Ω; for example, alternatively, the resistance of the heating element is 0.5Ω, 0.6Ω, 0.7Ω, 0.8Ω, 0.9Ω, 1Ω, 1.1Ω, 1.2Ω, 1.3 Ω, 1.4Ω, or 1.5Ω.

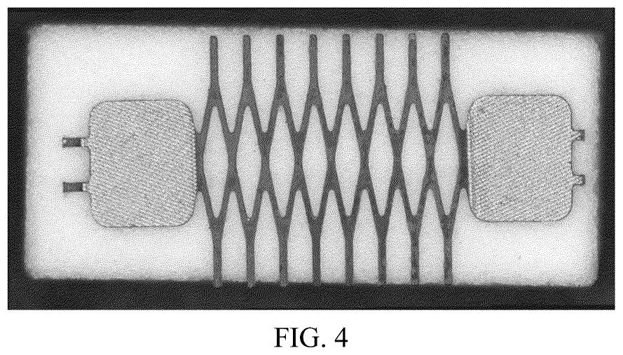

In an aspect, the shape of the heating element is rhombus or honeycomb. For example, as shown in FIG. 3 and FIG. 4, the heating element may consist of multiple rhombuses or multiple honeycombs. Further, the heating element consist of 1 to 15 rhombuses or 1 to 15 honeycombs.

In an aspect, the present disclosure provides a preparation method for the aforementioned atomization core, which is not specifically limited. It may include, for example, the following steps:
coating a transition layer paste onto the heating element, then attaching the heating element coated with the transition layer paste onto the porous substrate, followed by sintering and curing, and cooling, to obtain the atomization core.

Alternatively, it may include the following steps: coating the transition layer paste onto one side of the heating element, then attaching the side of the heating element coated with the transition layer paste onto the porous substrate, followed by sintering and curing, and cooling, to obtain the atomization core, where the transition layer in the atomization core is bonded between the porous substrate and the heating element.

Alternatively, it may include the following steps: coating the transition layer paste onto one side of the porous substrate, which may be performed using a screen template according to the shape of the heating element; then attaching the heating element onto the area of the porous substrate coated with the transition layer paste, followed by sintering and curing, and cooling, to obtain the atomization core, where the transition layer in the atomization core is bonded between the porous substrate and the heating element.

In an aspect, the sintering and curing temperature is 800° C. to 1000° C., the sintering and curing time is 8 min to 12 min; the heating rate for the sintering and curing is 8° C./min to 30° C./min; and the cooling is natural cooling to room temperature.

In an aspect, the paste thickness of the transition layer paste is 20 μm to 100 μm, where the transition layer paste, in addition to raw material powder such as glass powder, also includes an organic carrier such as a solvent and a binder. The solvent may typically be water-based or alcohol-based (e.g., terpineol). The binder may be cellulose-based such as methyl cellulose or ethyl cellulose.

In an aspect, the mass ratio of the raw material powder to the solvent to the binder in the transition layer paste is (70-200):(50-150):(20-80).

In an aspect, the preparation method for the atomization core may further include applying pressure using an external template during the sintering and curing.

The present disclosure further provides an atomizer, including the atomization core described above. The atomizer further includes a liquid storage tank for storing a liquid atomization substance and for guiding the atomization substance to the atomization core. The atomization core can atomize the atomization substance to generate an aerosol in an energized mode.

The present disclosure further provides an electronic atomization device, including the atomizer described above and a power supply component. The power supply component is used for supplying power to the atomizer in a preset manner.

In the following examples of the present disclosure, the porous substrates used and their preparation methods are as follows:

A first porous substrate includes multiple glass-ceramic bubbles, where adjacent glass-ceramic bubbles are directly bonded to each other through sintering; at least some of the glass-ceramic bubbles have openings; cavities inside the glass-ceramic bubbles having the openings are interconnected through the openings to form pores, and the pores extend through the porous glass-ceramic substrate and reach the surface of the porous glass-ceramic substrate.

A preparation method for the first porous substrate includes the following steps:
1) 100 g of glass bubbles (the raw material glass bubbles are soda-lime silicate glass, with particle size parameters: D10=18.61 μm, D50=39.38 μm, D90-69.47 μm, and an internal porosity of individual glass bubbles of 84.8%; main components: Si: 41.647 wt %, O: 49.375 wt %, Na: 3.778 wt %, Ca: 4.619 wt %, Mg: 0.201 wt %, Al: 0.379 wt %) are with 25 g of hydroxyethyl cellulose, 2.5 g of sodium stearate, and 48 g of water, and then subjected to extrusion molding to obtain a blank, with a molding pressure of 23 bar; and
2) the blank from step 1) is subjected to a first sintering, a second sintering, and a third sintering to obtain a porous glass-ceramic substrate, where the first sintering temperature is 220° C., and the first sintering time is 2 hours; the second sintering temperature is 600° C., and the second sintering time is 2 hours; the third sintering temperature is 1200° C., and the third sintering time is 1 hour, and finally furnace-cooled naturally to obtain a porous glass-ceramic substrate. The porosity of the porous substrate tested by mercury intrusion porosimetry is 62.01%, and the average pore size is 18.4 μm.

A second porous substrate has a longitudinal through pore structure extending vertically through upper and lower surfaces (the liquid absorbing surface and the atomization surface) of the ceramic substrate, and transverse curved through pore structures connected to the longitudinal through pores.

A preparation method for the second porous substrate includes the following steps:
1) nylon filaments are plain-woven into a mesh by alternating warp and weft threads, where the warp thread diameter of the mesh is 40 μm, with a spacing of 80 μm between adjacent warp threads; the weft thread diameter is 40 μm, with a spacing of 80 μm between adjacent weft threads; the mesh is fixed using a metal outer frame, then stacked and fixed with a fixture to form a three-dimensional organic template, where the number of layers is 80, and the thickness after stacking is 4 mm; and
2) 70 g of silicon dioxide powder, 10 g of sintering additive potassium feldspar, 4 g of acrylamide, 1 g of N,N′-methylenebisacrylamide, and 15 g of water are mixed; the pH is adjusted to 8.5 using ammonia water with a mass concentration of 15%; ball milling is performed to obtain a ceramic paste, where the ball milling speed is 50 rpm, and the ball milling time is 24 h; then, 1 g of ammonium persulfate and 0.5 g of tetramethylethylenediamine are added to the above ceramic paste, uniformly stirred and then filled into the above three-dimensional organic template, followed by drying, debinding, and sintering such that the three-dimensional organic template is ablated to form three-dimensional pores within the substrate, to obtain the porous ceramic substrate, where the drying ambient humidity is 50%, the drying temperature is 45° C., the drying time is 72 h, the debinding temperature is 500° C., the debinding time is 1800 min, the sintering temperature is 1150° C., and the sintering time is 1200 min. The porosity of the porous substrate tested by mercury intrusion porosimetry is 58%, and the average pore size is 40 μm.

A third porous substrate includes a skeleton and multi-directionally interconnected pores. The multi-directionally interconnected pores are spherical pores, each interconnected to at least 6 surrounding pores. A preparation method for the third porous substrate includes the following steps:

Glass powder is ball-milled in a planetary ball mill at 300 r/min for 3 h using ethanol as a solvent, followed by drying and sieving to obtain glass powder with a particle size of less than 5 μm; and crushed mullite chopped fibers is ball-milled in a planetary ball mill at 300 r/min for 6 hours using stearic acid as a grinding aid and ethanol as a solvent, followed by washing with ethanol, drying, and sieving through a 100-mesh sieve to obtain a fiber raw material. 13 volumes of glass powder (density 2.5 g/mL), 12 volumes of fiber (density 2.8 g/mL, same below), and 75 volumes of PMMA (80 μm) pore-forming agent are used as ingredients and mixed in a three-dimensional mixer for 2 h, the mixed material is added to a mixer, with 20% paraffin wax, 5% polyethylene, and 5% dispersion aid (dibutyl phthalate) added, internal mixing is performed at 180° C. for 2 h, and then a green compact is prepared via an injection molding machine, with the microscopic morphology as follows: within a single plane, the pore-forming agents are closely packed with approximately 6 surrounding pore-forming agents, showing a tendency for face-centered close-packing or hexagonal close-packing. The temperature is raised to 200° C. over 200 minutes, and then further raised to 500° C. at a rate of 0.5° C. per minute, with 2-hour holding periods set at 240° C., 280° C., 300° C., and 350° C. respectively; then the temperature is raised to 1180° C. at a rate of 5° C. per minute, held for 30 minutes, and then naturally cooled to room temperature to obtain a porous glass material with a fiber volume content of 48%, with the microscopic morphology of the sintered porous glass substrate as follows: after sintering of the closely packed pore-forming agents, a pore structure remains; within the same plane, the pores created by the pore-forming agents are interconnected with approximately 6 surrounding pores. The porosity of the porous substrate tested by mercury intrusion porosimetry is 72.0%, and the average pore size is 40 μm.

### Example 1

This example provides an atomization core, which is prepared through a method including the following steps:

A transition layer paste is coated onto one side of an 8-aperture rhombic 430 stainless steel mesh heating element, with a paste thickness of 50 μm, where the components of the transition layer paste include glass powder, terpineol, and methyl cellulose in a mass ratio of 100:80:20. The heating element has a thickness of 50 μm and a resistance of 0.7Ω. The side of the heating element coated with the transition layer paste is then attached onto the first porous substrate. The temperature is raised to 1000° C. for sintering and curing for 10 min, with a heating rate of 10° C./min, followed by natural cooling to room temperature, to obtain the atomization core. The transition layer in the atomization core is bonded between the porous substrate and the heating element.

Structural features of the atomization core prepared in this example are shown in FIG. 1, FIG. 2, FIG. 4, and FIG. 5. FIG. 1 is a schematic cross-sectional view of the atomization core, and FIG. 2 is a cross-sectional SEM image of the atomization core. As shown in the figures, the transition layer is bonded between the porous substrate and the heating element, and partially fills into the porous substrate. As shown in FIGS. 4 and 5, the transition layer fills an area where the heating element contacts the porous substrate. Areas on the atomization surface of the porous substrate not in contact with the heating element have intact pore structures and are not filled or covered by the transition layer. The ratio of an area where the transition layer fills the porous substrate to an area where the heating element covers the porous substrate is approximately 1:1. In addition, as shown in FIG. 2, the transition layer fills part of pores of the porous substrate, forming an embedded structure, and the transition layer structure is dense. Further, the maximum thickness of the transition layer is approximately 140 μm, and the minimum thickness is approximately 20 μm.

### Example 2

This example provides an atomization core, which is prepared through a method including the following steps:

A transition layer paste is coated onto one side of an 8-aperture rhombic iron-chromium-aluminum alloy mesh heating element, with a paste thickness of 50 μm, where the components of the transition layer paste include glass powder, terpineol, and methyl cellulose in a mass ratio of 200:150:80. The heating element has a thickness of 100 μm and a resistance of 1.1Ω. The side of the heating element coated with the transition layer paste is then attached onto the first porous substrate. The temperature is raised to 1000° C. for sintering and curing for 10 min, with a heating rate of 8° C./min, followed by natural cooling to room temperature, to obtain the atomization core. The transition layer in the atomization core is bonded between the porous substrate and the heating element.

The atomization core prepared in this example has structural features identical with or similar to those in Example 1, which will not be repeated here. The difference from the aforementioned example is that, in this example, the maximum thickness of the transition layer is approximately 70 μm, and the minimum thickness is approximately 30 μm.

### Example 3

This example provides an atomization core, which is prepared through a method including the following steps:

A transition layer paste is coated onto one side of an 8-aperture rhombic 430 stainless steel sheet heating element, with a paste thickness of 50 μm, where the components of the transition layer paste include glass powder, terpineol, and methyl cellulose in a mass ratio of 100:80:20. The heating element has a thickness of 50 μm and a resistance of 0.7Ω. Both sides are sandblasted to form a micro-nano structure and alter the surface roughness. The side of the heating element coated with the transition layer paste is then attached onto the first porous substrate. The temperature is raised to 1000° C. for sintering and curing for 12 min, with a heating rate of 30° C./min, followed by natural cooling to room temperature, to obtain the atomization core. The transition layer in the atomization core is bonded between the porous substrate and the heating element.

The atomization core prepared in this example has structural features identical with or similar to those in Example 1, which will not be repeated here. The difference from the aforementioned example is that, in this example, the surface of the heating element has a micro-nano structure, with a roughness Ra of 100 nm to 300 nm.

### Example 4

This example provides an atomization core, which is prepared through a method including the following steps:

A transition layer paste is coated onto one side of an 8-aperture rhombic iron-chromium-aluminum alloy mesh heating element, with a paste thickness of 50 μm, where the components of the transition layer paste include glass powder, terpineol, and methyl cellulose in a mass ratio of 100:80:20. The heating element has a thickness of 100 μm and a resistance of 1.1Ω. Both sides are sandblasted to form a micro-nano structure and alter the surface roughness. The side of the heating element coated with the transition layer paste is then attached onto the first porous substrate. The temperature is raised to 1000° C. for sintering and curing for 10 min, with a heating rate of 8° C./min, followed by natural cooling to room temperature, to obtain the atomization core. The transition layer in the atomization core is bonded between the porous substrate and the heating element.

The atomization core prepared in this example has structural features similar to those in Example 3, which will not be repeated here.

### Example 5

This example provides an atomization core, which is prepared through a method including the following steps:

A transition layer paste is coated onto one side of an 8-aperture rhombic 430 stainless steel mesh heating element, with a paste thickness of 50 μm, where the components of the transition layer paste include glass powder, terpineol, and methyl cellulose in a mass ratio of 100:80:20. The heating element has a thickness of 50 μm and a resistance of 0.7Ω. Both sides are sandblasted to form a micro-nano structure and alter the surface roughness. The side of the heating element coated with the transition layer paste is then attached onto the first porous substrate. The temperature is raised to 1000° C. for sintering and curing for 10 min, with a heating rate of 8° C./min, followed by natural cooling to room temperature, to obtain the atomization core. The transition layer in the atomization core is bonded between the porous substrate and the heating element.

The atomization core prepared in this example has structural features similar to those in Example 3, which will not be repeated here.

### Example 6

This example provides an atomization core, which is prepared through a method including the following steps:

A transition layer paste is coated onto one side of an 8-aperture rhombic 316L stainless steel mesh heating element, with a paste thickness of 50 μm, where the components of the transition layer paste include glass powder, terpineol, and methyl cellulose in a mass ratio of 100:80:20. The heating element has a thickness of 50 μm and a resistance of 0.8Ω. Both sides are sandblasted to form a micro-nano structure and alter the surface roughness. The side of the heating element coated with the transition layer paste is then attached onto the first porous substrate. The temperature is raised to 1000° C. for sintering and curing for 10 min, with a heating rate of 8° C./min, followed by natural cooling to room temperature, to obtain the atomization core. The transition layer in the atomization core is bonded between the porous substrate and the heating element.

The atomization core prepared in this example has structural features similar to those in Example 3, which will not be repeated here.

### Example 7

This example provides an atomization core, which is prepared through a method including the following steps:

A transition layer paste is coated onto one side of an 8-aperture rhombic 430 stainless steel mesh heating element, with a paste thickness of 50 μm, where the components of the transition layer paste include glass powder, terpineol, and methyl cellulose in a mass ratio of 100:80:20. The heating element has a thickness of 50 μm and a resistance of 0.7Ω. The side of the heating element coated with the transition layer paste is then attached onto the third porous substrate. The temperature is raised to 1000° C. for sintering and curing for 12 min, with a heating rate of 30° C./min, followed by natural cooling to room temperature, to obtain the atomization core. The transition layer in the atomization core is bonded between the porous substrate and the heating element.

The atomization core prepared in this example has structural features similar to those in Example 1, which will not be repeated here.

### Example 8

This example provides an atomization core, which is prepared through a method including the following steps:

A transition layer paste is coated onto one side of an 8-aperture rhombic 430 stainless steel mesh heating element, with a paste thickness of 50 μm, where the components of the transition layer paste include glass powder, terpineol, and methyl cellulose in a mass ratio of 100:80:20. The heating element has a thickness of 50 μm and a resistance of 0.7Ω. The side of the heating element coated with the transition layer paste is then attached onto the second porous substrate. The temperature is raised to 1000° C. for sintering and curing for 12 min, with a heating rate of 30° C./min, followed by natural cooling to room temperature, to obtain the atomization core. The transition layer in the atomization core is bonded between the porous substrate and the heating element.

The atomization core prepared in this example has structural features similar to those in Example 1, which will not be repeated here. The difference from the aforementioned examples is that, in this example, because the second porous substrate has ordered pores, the infiltration depth of the transition layer is relatively uniform.

### Test Example 1

The atomization cores of Example 1 to Example 6 of the present disclosure were tested for dry heating service life and wet heating service life tests. Dry heating service life refers to: when the heating element is heated as a bare heating element under the operating power (7.5 W to 8 W), with a test cycle of 3 s puff and 8 s pause, the condition of the bare heating element is evaluated through cyclic testing. This can be used to determine the bonding strength performance. If the strength is insufficient, abnormal phenomena such as warping and detachment from the substrate or fracture of the heating element may occur during the test. Wet heating service life refers to: when the heating element is normally installed in the atomizer for inhalation, under the operating power (7.5 W to 8 W), with a test cycle of 3 s puff and 27 s pause, the condition of the heating element in the atomizer is evaluated through cyclic testing. This can be used to determine the bonding strength performance. If the strength is insufficient, abnormal phenomena such as warping and detachment from the substrate, fracture, or failure of the heating element may occur during the test. When determining failure, the atomization core is considered failed if any one of the following conditions is met: 1) the resistance of the atomization core changes significantly abnormally (e.g., a significant increase in resistance exceeding 20% of the original resistance due to fracture or detachment of the heating element); and 2) the aerosol output is less than half of the initial atomization amount. The test conditions and results of this test example are shown in Table 1 below.

TABLE 1

| | | Dry | Wet | Warping | Failure | Warping | Failure |
|---|---|---|---|---|---|---|---|
| | | heating | heating | in dry | in dry | in wet | in wet |
| | Test conditions | service life | service life | heating | heating | heating | heating |
| Example | Fruit-flavored | 3 s puff, | 3 s puff, | No | No | No | No |
| 1 | e-liquid, | 8 s pause, ≥15 | 27 s pause, | | | | |
| | power: 7.5 W | puffs | 1500 puffs | | | | |
| Example | Fruit-flavored | 3 s puff, | 3 s puff, | No | No | No | No |
| 2 | e-liquid, | 8 s pause, ≥15 | 27 s pause, | | | | |
| | power: 7.5 W | puffs | 1500 puffs | | | | |
| Example | Fruit-flavored | 3 s puff, | 3 s puff, | No | No | No | No |
| 3 | e-liquid, | 8 s pause, ≥15 | 27 s pause, | | | | |
| | power: 7.5 W | puffs | 1500 puffs | | | | |
| Example | Fruit-flavored | 3 s puff, | 3 s puff, | No | No | No | No |
| 4 | e-liquid, | 8 s pause, ≥15 | 27 s pause, | | | | |
| | power: 7.5 W | puffs | 1500 puffs | | | | |
| Example | Tobacco- | 3 s puff, | 3 s puff, | No | No | No | No |
| 5 | flavored | 8 s pause, ≥15 | 27 s pause, | | | | |
| | e-liquid, | puffs | 500 puffs | | | | |
| | power: 8 W | | | | | | |
| Example | Tobacco- | 3 s puff, | 3 s puff, | No | No | No | No |
| 6 | flavored | 8 s pause, ≥15 | 27 s pause, | | | | |
| | e-liquid, | puffs | 500 puffs | | | | |
| | power: 8 W | | | | | | |

As shown in Table 1, in the actual use environment involving thermal shock within the atomization core, because most of the heating element is in tight contact with the porous substrate, its deformation is constrained. Under thermal shock, the deformation of each part of the heating element is relatively consistent and constrained, making it less prone to occurrences such as warping or fracture, thereby extending the service life of the atomization core.

### Test Example 2

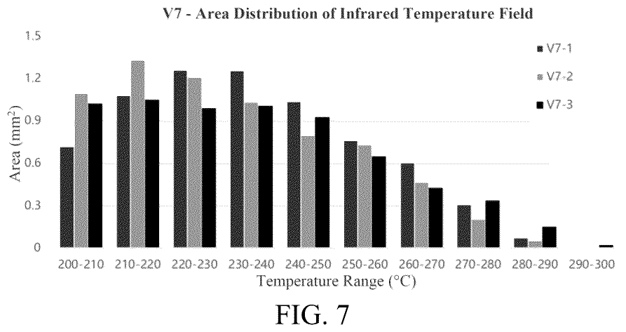

Multiple samples of the atomization cores prepared in Example 1 and Example 2 of the present disclosure were subjected to a temperature field test. The temperature field distribution of the atomization core was obtained using an infrared thermometer, followed by statistical analysis of the temperature field distribution. The test results are shown in Table 2, and FIG. 6 and FIG. 7. The maximum temperature of the heating element is approximately 292° C. As shown in FIG. 7, which depicts multiple different samples prepared in Example 1, the differences in temperature field distribution among the multiple different samples are small, indicating good product consistency.

TABLE 2
Temperature Field Test

| | Temperature field |
|---|---|
| Example 1 | Tobacco e-liquid, power: 8 W, maximum |
| | temperature: 290° C. to 300° C. |
| Example 2 | Tobacco e-liquid, power: 8.5 W, maximum |
| | temperature: 290° C. to 310° C. |

### Test Example 3

The atomizers corresponding to the atomization cores of Example 1, Example 7, and Example 8 were subjected to aerosol output tests and noise tests. Aerosol output attenuation refers to the difference between the minimum aerosol output and the maximum aerosol output within a preset service life cycle; Aerosol output attenuation=(maximum aerosol output−minimum aerosol output)/maximum aerosol output*100%. Typically, the aerosol output shows a decaying trend, meaning the maximum aerosol output is the initial output, and the minimum aerosol output is the final aerosol output. The test conditions were constant power of 8 W, and the tested atomization substance was a commercially available tobacco-flavored liquid atomization substance (“Hewuloutou”). The test results are shown in Table 3.

TABLE 3

| Test indicators | Example 7 | | Example 8 | | Example 1 | |
|---|---|---|---|---|---|---|
| Finished product aerosol | 8.95 | | 8.43 | | 8.85 | |
| content (mg/puff) | | | | | | |
| Finished product wet heating | ≥500 | puffs | ≥500 | puffs | ≥500 | puffs |
| service life (puff) | | | | | | |
| Aerosol output attenuation | 15.3% | | 12.9% | | 5.3% | |
| Noise | <40 | dB | <40 | dB | <40 | dB |

Combining the results of Test Example 2 and Test Example 3, the atomization cores prepared in the examples of the present disclosure also exhibit good consistency and long service life. The technical effect of good consistency is reflected in the following aspects: first, the consistency among different samples from the same batch is good.

As shown in FIG. 6, the differences in the temperature curves among the three samples from Example 1 (denoted as V7-1, V7-2, and V7-3, respectively) are extremely small. The inventors analyze that, by providing the transition layer, the consistency of the gap between the heating element and the porous substrate is improved, reducing the influence of deformation of the porous substrate and the heating element, thereby enhancing product consistency among different samples. Second, the consistency of the same sample throughout its service life cycle is good, manifested as small aerosol output attenuation and long service life. As shown in Table 3, during a usage cycle of ≥500 puffs, at 500 puffs, the attenuation for Example 7 is about 15.3%, while the attenuation for Example 1 is only 5.3%, which is far lower than the attenuation levels in the prior art. Simultaneously, the inhalation noise is all less than 40 decibels. Typically, the level of inhalation noise can comprehensively reflect, from an indirect perspective, the liquid supply capability and atomization effect of the atomization core. Excessive noise often indicates problems such as localized dry heating or an overly thick e-liquid film in the atomization core. Referring to FIG. 7, the temperature field distribution is consistent among different samples of Example 1. In addition, the temperature field distribution across the atomization surface of the atomization core is improved, avoiding localized high temperatures and reducing the occurrence of dry heating.

Based on the above test results and analysis, the present disclosure achieves comprehensive improvements and enhancements in at least multiple dimensions including the temperature field distribution of the atomization core, the consistency of the atomization core, service life, mechanical properties, and dry heating, thus improving the performance of the atomization core and solving the problems existing in the prior art.

Obviously, the above examples are merely illustrations for clear description and not limitations on the examples. For those of ordinary skill in the art, other different forms of changes or variations could be made on the basis of the above description. Here, it is neither necessary nor feasible to exhaustively enumerate all possible implementation modes. Moreover, any obvious variations or modifications derived therefrom still fall within the scope of protection of the present disclosure.

What is claimed is:

1. An atomization core comprising:
a porous substrate,
a heating element, and
a transition layer between the porous substrate and the heating element, wherein the transition layer at least partially fills and/or covers the porous substrate.

2. The atomization core of claim 1, wherein
the transition layer contains a glassy phase.

3. The atomization core of claim 2, wherein
the softening point temperature of glass in the transition layer is 400° C. to 1100° C.

4. The atomization core of claim 1, wherein the porous substrate contains a glassy phase and/or a ceramic phase.

5. The atomization core of claim 1, wherein the transition layer contains an inorganic material component that is greater than 80 wt %, greater than 90 wt %, or 100 wt %.

6. The atomization core of claim 1, wherein
the transition layer at least partially fills and/or covers an area of the porous substrate where the heating element is in contact; and
an area of the porous substrate not in contact with the heating element is at least partially not filled and/or covered by the transition layer.

7. The atomization core of claim 6, wherein the transition layer fills part of pores of the porous substrate, forming an embedded structure;
and/or, the transition layer is a dense structure.

8. The atomization core of claim 1, wherein a thickness of the transition layer is 20 μm to 200 μm.

9. The atomization core of claim 1, wherein the transition layer comprises aluminosilicate glass and/or barium silicate glass; and
the porous substrate comprises soda-lime silicate glass and/or borosilicate glass.

10. The atomization core of claim 1, wherein a porosity of the porous substrate is 20% to 90%.

11. The atomization core of claim 1, wherein an average pore size of the porous substrate is 10 μm to 300 μm.

12. The atomization core of claim 11, wherein pores of the porous substrate comprise ordered straight through pores, or ordered tortuous through pores.

13. The atomization core of claim 1, wherein the heating element is a metal mesh or a metal sheet;
and/or, the material of the heating element is selected from at least one of iron-based alloy materials, nickel-based alloy materials, stainless steel, or iron-chromium-aluminum alloy.

14. The atomization core of claim 1, wherein a shape of the heating element is rhombus or honeycomb.

15. The atomization core of claim 1, wherein a thickness of the heating element is 20 μm to 200 μm.

16. The atomization core of claim 14, wherein at least part of the surface of the heating element has a micro-nano structure;
the surface roughness Ra of the heating element having the micro-nano structure is 100 nm to 300 nm.

17. The atomization core of claim 1, wherein a ratio of an area where the transition layer fills and/or covers the porous substrate to an area where the heating element covers the porous substrate is (0.8-1.2):1.

18. An atomizer comprising:
an atomization core including:
a porous substrate,
a heating element, and
a transition layer between the porous substrate and the heating element, wherein the transition layer at least partially fills and/or covers the porous substrate.

19. An electronic atomization device comprising:
a power supply component; and
an atomization core including:
a porous substrate,
a heating element, and
a transition layer between the porous substrate and the heating element, wherein the transition layer at least partially fills and/or covers the porous substrate.
